(19) United States
(12) Patent Application Publication
(10) Pub. No.: US 2009/0081473 A1
(43) Pub. Date: Mar. 26, 2009

(54) FRICTION TRANSMISSION BELT AND PROCESS FOR PRODUCING THE SAME

(75) Inventor: Kimichika Ohno, Hyogo (JP)

Correspondence Address: DENNISON, SCHULTZ & MACDONALD, 1727 KING STREET, SUITE 105, ALEXANDRIA, VA, 22314, US

(73) Assignee: BANDO CHEMICAL INDUSTRIES, LTD., Kobe-shi, Hyogo (JP)

(21) Appl. No.: 11/908,998

(22) PCT Filed: Apr. 14, 2006
(86) PCT No.: PCT/JP2006/307920

§ 371 Date: Nov. 14, 2007

(30) Foreign Application Priority Data
Apr. 15, 2005 (JP) 2005-118629

(51) Int. Cl. B32B 25/00; B32B 38/08

(52) U.S. Cl. 428/515; 156/137

(57) ABSTRACT

It is an object of the present invention to provide a friction transmission belt which is superior in adhesive properties such as dynamic adhesion and heat resistant adhesion on repeated flexing of a friction transmission belt or on running under heating conditions around an engine, and is also superior in desired performance such as heat resistance, abrasion resistance and an abnormal noise-preventing property. The present invention pertains to a friction transmission belt formed by laminating an adhesive rubber layer in which core cords are embedded along the longitudinal direction of the belt and a compressed rubber layer, wherein the above-mentioned adhesive rubber layer is formed by crosslinking an ethylene-α-olefin elastomer compound with organic peroxide, the above-mentioned compressed rubber layer is formed by crosslinking an ethylene-α-olefin elastomer compound, and the above-mentioned core cord is subjected to an adhesive treatment by a resorcin-formalin-latex adhesive composition containing a 2,3-dichlorobutadiene-containing polymer latex.

### TECHNICAL FIELD

The present invention relates to a friction transmission belt and a method of producing the same.

### BACKGROUND ART

As a friction transmission belt, generally, belts having a compressed rubber layer and an adhesive rubber layer, in which fiber core cords are bonded and embedded in the adhesive rubber layer and a rubber-lined canvas is bonded to all peripheral faces of the belt including a top face, a bottom face or side faces as required, are widely used. Hitherto, in such a friction transmission belt, chloroprene rubber, hydrogenated nitrile rubber, and chlorosulfonated polyethylene rubber are usually used for the compressed rubber layer, but in recent years, there are requests for dechlorination for rubbers which are materials of a friction transmission belt from the viewpoint of environmental protection. Responding to this request, ethylene-α-olefin elastomers such as ethylene-propylene-diene rubber (EPDM) are used for the adhesive rubber layer in addition to the compressed rubber layer.

In Patent Document 1, a power transmission belt, formed by laminating the adhesive rubber layer which uses a vulcanized substance of a rubber composition capable of crosslinking by sulfur, using ethylene-α-olefin elastomer and in which core cords are embedded, and the compressed rubber layer which uses a crosslinked substance of a rubber composition capable of crosslinking with organic peroxide, using ethylene-α-olefin elastomer, is disclosed. In Patent Document 2, a transmission belt including the adhesive rubber layer and the compressed rubber layer, formed by adding N,N′-m-phenylenedimaleimide to ethylene-α-olefin elastomer and vulcanizing the resulting mixture with peroxide, is disclosed. These belts are aimed at improving performance such as heat resistance, low temperature resistance, durability and adhesive wear resistance.

However, in the case of Patent Document 1, adhesion is secured to some extent, but when oil sprinkles the adhesive rubber layer, this leads to early failures of the belt since physical properties of the adhesive rubber layer are deteriorated due to oil and stress is concentrated at the location where physical properties are deteriorated. In Patent Document 2, an adhesive force between the adhesive rubber layer and the core cords is not adequately satisfactory. In addition, an adhesive composition to be used for improving such an adhesive force is not investigated in detail. Further, substances formed by crosslinking the adhesive rubber layer with organic peroxide are not investigated in detail.

In Patent Document 3, a transmission belt, in which an adhesive rubber layer in which core cords made of polyester fiber are embedded is bonded by vulcanization to a compressed rubber layer, both the adhesive rubber layer and the compressed rubber layer are composed of a vulcanized substance of an ethylene-α-olefin elastomer compound, and the core cord is subjected to an adhesive treatment by a resorcin-formalin-latex adhesive composition, is disclosed. It is also disclosed to use a substance comprising chlorosulfonated polyethylene and alkylated chlorosulfonated polyethylene in an amount of 50 to 100% by weight, and 2-chloro-1,3-butadiene-2,3-dichloro-1,3-butadiene copolymer rubber in an amount of 50% by weight or less as a latex component of the above-mentioned adhesive composition.

But, since ethylene-α-olefin elastomer such as ethylene-propylene-diene rubber (EPDM) is resistant to adhesion, it has a problem that an adhesive force is apt to deteriorate at the interface between the resorcin-formalin-latex adhesive and the rubber, and it does not have an adequate adhesive force. In addition, a substance formed by crosslinking the adhesive rubber layer with organic peroxide is not investigated in detail.

Patent Document 1: Japanese Kokai Publication No. Hei-11-193849

Patent Document 2: Japanese Kokai Publication No. Hei-11-349752

Patent Document 3: Japanese Kokai Publication No. 2001-003991

### SUMMARY OF THE INVENTION

In view of the above state of the art, it is an object of the present invention to provide a friction transmission belt which is superior in adhesive properties such as dynamic adhesion and heat resistant adhesion on repeated flexing of a friction transmission belt or on running under heating conditions around an engine, and is also superior in desired performance such as heat resistance, abrasion resistance and an abnormal noise-preventing property.

The present invention pertains to a friction transmission belt formed by laminating an adhesive rubber layer in which core cords are embedded along the longitudinal direction of the belt and a compressed rubber layer,

wherein the above-mentioned adhesive rubber layer is formed by crosslinking an ethylene-α-olefin elastomer compound with organic peroxide,

the above-mentioned compressed rubber layer is formed by crosslinking an ethylene-α-olefin elastomer compound, and

the above-mentioned core cord is subjected to an adhesive treatment by a resorcin-formalin-latex adhesive composition containing a 2,3-dichlorobutadiene-containing polymer latex.

The above-mentioned 2,3-dichlorobutadiene-containing polymer latex preferably contains 2-chloro-1,3-butadiene-2,3-dichloro-1,3-butadiene copolymer rubber.

The above-mentioned both an ethylene-α-olefin elastomer compound for forming the adhesive rubber layer and an ethylene-α-olefin elastomer compound for forming the compressed rubber layer preferably contain ethylene-propylene-diene rubber.

Further, the present invention pertains to a method of producing a friction transmission belt formed by laminating an adhesive rubber layer in which core cords are embedded along the longitudinal direction of the belt and a compressed rubber layer, including the steps of

(1) impregnating the core cords with the resorcin-formalin-latex adhesive composition containing the 2,3-dichlorobutadiene-containing polymer latex and heating and drying the core cords to be subjected to an adhesive treatment,

(2) placing the core cords subjected to an adhesive treatment, obtained by the above-mentioned step (1), between unvulcanized ethylene-α-olefin elastomer compound sheets for forming the adhesive rubber layer to obtain a sheet, and laminating an unvulcanized ethylene-α-olefin elastomer compound sheet for forming the compressed rubber layer on the obtained sheet to obtain a laminate, and

(3) pressurizing and heating the laminate obtained in the above-mentioned step (2) to vulcanize it,

wherein the above-mentioned unvulcanized ethylene-α-olefin elastomer compound sheet for forming the adhesive rubber layer is prepared by using an ethylene-α-olefin elastomer compound containing

Hereinafter, the present invention will be described in detail.

### DETAILED DESCRIPTION OF THE INVENTION

The friction transmission belt of the present invention is characterized in that the adhesive rubber layer is formed by crosslinking an ethylene-α-olefin elastomer compound with organic peroxide and the compressed rubber layer is formed by crosslinking an ethylene-α-olefin elastomer compound. The friction transmission belt of the present invention is also characterized in that the core cord embedded in the adhesive rubber layer is subjected to an adhesive treatment by a resorcin-formalin-latex adhesive composition containing a 2,3-dichlorobutadiene-containing polymer latex.

When ethylene-α-olefin elastomer such as EPDM is applied to crosslinking by peroxide, it is known that there is a problem that the tear strength of crosslinked rubber is generally low (“Rubber Industry Handbook (4th edition)”, p. 304-305, The Society of Rubber Industry, Japan (corporation aggregate), December, 1993). It is also known that there is a problem that if crosslinking by peroxide is employed in a friction transmission belt using ethylene-α-olefin elastomer, the tear strength becomes low and the core cords tend to pop out during running the belt since the tear strength of a crosslinked substance by organic peroxide of ethylene-α-olefin elastomer such as ethylene propylene rubber is generally low like this (Patent Document 1, p. 2).

Despite low tear strength of the adhesive rubber layer, the friction transmission belt of the present invention has very excellent dynamic adhesion beyond expectation by combination of using the 2,3-dichlorobutadiene-containing polymer latex as a latex component of the resorcin-formalin-latex adhesive composition in an adhesive treatment of the core cord and the adhesive rubber layer formed by using the ethylene-α-olefin elastomer compound and crosslinking it with organic peroxide.

The reason why the very excellent dynamic adhesion is attained by such a combination is unclear, but it is inferred that the excellent dynamic adhesion is due to increased chemical compatibility and reactivity at the interface between the 2,3-dichlorobutadiene-containing polymer latex and the adhesive rubber layer crosslinked with organic peroxide.

As described above, the friction transmission belt of the present invention has excellent adhesive properties (adhesion between the adhesive rubber layer and the core cords, adhesion between the adhesive rubber layer and the compressed rubber layer, etc.) such as dynamic adhesion and heat resistant adhesion. Therefore, excellent dynamic life can be attained at the time of running the belt and excellent durability can be attained. Accordingly, it is possible to prevent well the occurrence of failures such as the exposure of core cord out of the belt (popping out), the occurrence of the break at the interface between the adhesive rubber layer and the compressed rubber layer, and the occurrence of cracks on the rubber layer at the time of running the belt. Particularly in the present invention, since the adhesion between the adhesive rubber layer and the core cords can be improved, popping out can be prevented well.

The friction transmission belt is formed by laminating the adhesive rubber layer and the compressed rubber layer. In the friction transmission belt, the adhesive rubber layer is formed by crosslinking an ethylene-α-olefin elastomer compound (a compound comprising ethylene-α-olefin elastomer, organic peroxide, and other components as required) with organic peroxide. The compressed rubber layer is formed by crosslinking an ethylene-α-olefin elastomer compound (a compound comprising ethylene-α-olefin elastomer, and other components as required). Thereby, excellent dynamic adhesion, excellent heat resistant adhesion, and excellent dynamic life can be attained.

As ethylene-α-olefin elastomer contained in the ethylene-α-olefin elastomer compound for forming the adhesive rubber layer and the compressed rubber layer, for example, rubber comprising a copolymer of α-olefin excluding ethylene, ethylene and diene (unconjugated diene), rubber comprising a copolymer of α-olefin excluding ethylene and ethylene, a partially halogen-substituted product thereof, or a mixture of two or more species thereof is employed. As the α-olefin excluding ethylene, at least one selected from the group consisting of propylene, butene, hexene and octane is preferably used. As ethylene-α-olefin elastomer, among others, ethylene-propylene-diene rubber (hereinafter, also referred to as an EPDM), ethylene-propylene copolymer (EPM), ethylene-butene copolymer (EBM), ethylene-octene copolymer (EOM), a halogen-substituted product thereof (particularly, a chlorine-substituted product) or a mixture of two or more species thereof is preferably used. It is particularly preferred to use EPDM. As the ethylene-α-olefin elastomer used for the adhesive rubber layer and the compressed rubber layer, respectively, the same elastomers may be used or different elastomers may be used, but it is preferred to use the same elastomers.

In the ethylene-α-olefin elastomer used for the adhesive rubber layer and the compressed rubber layer, the content of ethylene is preferably 50 to 80% by weight with respect to 100% by weight of the total amount of ethylene, α-olefin and diene which constitute the ethylene-α-olefin elastomer. The content of α-olefin is preferably 20 to 50% by weight.

As the diene component, generally, unconjugated dienes such as 1,4-hexadiene, dicyclopentadiene, ethylidene norbornane and the like are appropriately used. These dienes may be used alone or in combination of two or more species.

In the ethylene-α-olefin elastomer, unconjugated dienes preferably have an iodine value of elastomer of 50 or less, and more preferably an iodine value of elastomer of 4 to 40. As for viscosity of the ethylene-α-olefin elastomer, ethylene-α-olefin elastomer having Mooney viscosity ML₁₊₄ (100° C.) of 20 to 120 is preferably used.

Examples of commercialized product of the ethylene-α-olefin elastomer include X-3012P, 3085 (trade name, produced by Mitsui Chemicals, Inc.), EP-21, EP-65 (trade name, produced by JSR Corp.), and 5754, 582F (trade name, produced by Sumitomo Chemical Co., Ltd.).

In the friction transmission belt, the adhesive rubber layer is formed by crosslinking an ethylene-α-olefin elastomer compound for forming an adhesive rubber layer with organic peroxide. Thereby, excellent dynamic adhesion, excellent heat resistant adhesion, and excellent dynamic life can be attained.

The organic peroxide is not particularly limited, and examples of the organic peroxide include dialkyl peroxides such as di-t-butylperoxide, di-t-amylperoxide, t-butylcumyl peroxide, dicumyl peroxide, di(2-t-butyl-peroxyisopropyl)benzene, 2,2-di-t-butylperoxybutane, 2,5-dimethyl-2,5-di(t-butylperoxy)hexane, 2,5-dimethyl-2,5-di(t-butylperoxy)hexine-3, n-butyl-4,4-di(t-butylperoxy)valerate, 1,1-di-t-butylperoxycyclohexane, di-t-butylperoxy-3,3,5-trimethylcyclohexane and 2,2-bis(4,4-di-t-butylperoxycyclohexyl)propane; peroxy esters such as t-butylperoxy acetate, t-butylperoxy isobutylate, t-butylperoxy pivalate, t-butylperoxy maleate, t-butylperoxy neodecanoate, t-butylperoxy benzoate, di-t-butylperoxy phthalate, t-butylperoxy dilaurate, 2,5-dimethyl-2,5-di(benzoylperoxy)hexane, and t-butylperoxy isopropylcarbonate; ketone peroxides such as dicyclohexanone peroxide and the like; and mixtures thereof. Among others, organic peroxides, in which a temperature yielding a half-life of 1 minute is in a range of 130 to 200° C., is preferred, and particularly dicumyl peroxide, 2,5-dimethyl-2,5-di(t-butylperoxy)hexane, and di(2-t-butyl-peroxyisopropyl)benzene can be suitably used. In this case, excellent dynamic adhesion, excellent heat resistant adhesion, and excellent dynamic life can be attained. These organic peroxides may be used alone or in combination of two or more species.

In the friction transmission belt, the compressed rubber layer is formed by crosslinking an ethylene-α-olefin elastomer compound for forming a compressed rubber layer. The crosslinking of the compressed rubber layer may be crosslinking by organic peroxide or may be vulcanization by sulfur, but among others, it is preferred to be crosslinking by organic peroxide. Thereby, dynamic adhesion, heat resistant adhesion, and dynamic life can be further improved. Further, since the friction transmission belt can be integrated, oil resistance, low temperature resistance, and heat resistance can be improved.

When the crosslinking of the compressed rubber layer is crosslinking by organic peroxide, the compressed rubber layer is formed by crosslinking an ethylene-α-olefin elastomer compound (a compound comprising ethylene-α-olefin elastomer, organic peroxide, and other components as required) with organic peroxide. In this case, examples of the organic peroxide capable of being used in the compressed rubber layer include the same compounds as those exemplified in the descriptions of the adhesive rubber layer. In the adhesive rubber layer and the compressed rubber layer, respectively, the same organic peroxides may be used, or different organic peroxides may be used.

When the crosslinking of the compressed rubber layer is vulcanization by sulfur, the compressed rubber layer is formed by crosslinking an ethylene-α-olefin elastomer compound (a compound comprising ethylene-α-olefin elastomer, sulfur, and other components as required) with sulfur.

When the crosslinking of the compressed rubber layer is vulcanization by sulfur, an amount of sulfur to be added is preferably 1 to 3 parts by weight with respect to 100 parts by weight (solid matter) of ethylene-α-olefin elastomer in the ethylene-α-olefin elastomer compound for forming a compressed rubber layer. In the case of the vulcanization by sulfur, vulcanization accelerators may be compounded. By compounding the vulcanization accelerator to increase a degree of vulcanization, it is possible to prevent a problem such as adhesive wear. The vulcanization accelerator may be used as long as it is generally used as a vulcanization accelerator, and examples of the vulcanization accelerators include N-oxydiethylene-benzothiazole-2-sulfenamide (OBS), tetramethylthiuram disulfide (TMTD), tetraethylthiuram disulfide (TETD), zinc dimethyldithiocarbamate (ZnMDC), zinc diethyldithiocarbamate (ZnEDC), N-cyclohexylbenzothiazole-2-sulfenamide, 2-mercaptobenzothiazole, and dibenzothiazolyl disulfide.

When the adhesive rubber layer and the compressed rubber layer are obtained by using an ethylene-α-olefin elastomer compound containing ethylene-α-olefin elastomer and organic peroxide, the above compound may contain a crosslinking aid (a co-crosslinking agent). By compounding the crosslinking aid, it is possible to increase a crosslinking degree to further stabilize an adhesion force and to prevent problems such as adhesive wear and the like.

Examples of the crosslinking aid include substances usually used for crosslinking by peroxide such as TAIC, TAC, 1,2-polybutadiene, 1,2-polybutadiene modified with maleic anhydride, metal salts of unsaturated carboxylic acid, oximes, guanidine, trimethylolpropane trimethacrylate, ethyleneglycol dimethacrylate, N,N′-m-phenylenebismaleimide and sulfur. Among others, trimethylolpropane trimethacrylate, metal salts of unsaturated carboxylic acid, TAIC, and 1,2-polybutadiene modified with maleic anhydride are preferred in that excellent dynamic adhesion, excellent heat resistant adhesion, and excellent dynamic life can be attained. These crosslinking aids may be used singly or in combination of two or more species.

In the present invention, the ethylene-α-olefin elastomer compound for forming the adhesive rubber layer and the compressed rubber layer may contain a rubber component other than the ethylene-α-olefin elastomer within the bounds of not interfering with the effect of the present invention. The ethylene-α-olefin elastomer compound may also contain various agents commonly used in rubber industries, for example, reinforcing materials such as carbon black, silica, glass fiber, ceramic fiber and the like, fillers such as calcium carbonate, talc and the like, plasticizers, stabilizers, processing aids, coloring materials and the like as required in addition to the above-mentioned components.

The ethylene-α-olefin elastomer compound for forming the adhesive rubber layer can be obtained by uniformly mixing ethylene-α-olefin elastomer and organic peroxide, together with agents described above as required, with a usual mixing means such as a roll mixer, a Banbury mixer or the like. The ethylene-α-olefin elastomer compound for forming the compressed rubber layer can also be obtained by uniformly mixing ethylene-α-olefin elastomer, organic peroxide and/or sulfur, together with agents described above as required, by the same method. The ethylene-α-olefin elastomer compound for forming the adhesive rubber layer and the compressed rubber layer may be the same elastomer compounds or may be different elastomer compounds. The adhesive rubber layer and the compressed rubber layer can be produced by a conventionally known method.

The friction transmission belt is formed, for example, by bonding the adhesive rubber layer to the compressed rubber layer by vulcanization. A method of the above-mentioned bonding by vulcanization is not particularly limited, and methods which are conventionally known in crosslinking by organic peroxide and vulcanization by sulfur may be employed.

Core cords are embedded in the adhesive rubber layer along the longitudinal direction of the belt.

As the core cord, a polyester core cord, a nylon core cord, a vinylon core cord, and an aramide core cord are suitably used. As the polyester core cord, polyethylene terephthalate and polyethylene naphthalate are suitably used, and as the nylon core cord, 6,6-nylon (polyhexamethylene adipamide) and 6 nylon are suitably used. As the aramide core cord, for example, copolyparaphenylene-3,4′-oxydiphenylene-terephthalamide and polyparaphenylene terephthalamide, and polymethaphenylene isophthalamide are suitably used.

The core cord is subjected to an adhesive treatment by a resorcin-formalin-latex adhesive composition (hereinafter, also referred to as an RFL adhesive composition) containing a 2,3-dichlorobutadiene-containing polymer latex. By using the 2,3-dichlorobutadiene-containing polymer latex, the adhesion between the RFL adhesive composition and the core cord can be more enhanced, and excellent dynamic adhesion, excellent heat resistant adhesion, and excellent dynamic life can be attained.

The 2,3-dichlorobutadiene-containing polymer latex is a latex of a polymer having 2,3-dichloro-1,3-butadiene as a monomer unit, and can be obtained by a conventionally known emulsion polymerization process. In the 2,3-dichlorobutadiene-containing polymer latex, a copolymer of 2,3-dichloro-1,3-butadiene and another monomer which can be copolymerized with 2,3-dichloro-1,3-butadiene can be used as required. Examples of the another monomer which can be copolymerized include ethylene, propylene, chloroprene, butadiene, isoprene, vinyl chloride, vinylidene chloride, vinyl acetate, styrene, acrylonitrile, maleic anhydride, acrylic acid ester, methacrylic acid ester, and the like. These monomers may be used alone or in combination of two or more species.

Preferably, the 2,3-dichlorobutadiene-containing polymer latex contains 2-chloro-1,3-butadiene-2,3-dichloro-1,3-butadiene copolymer (DCB) rubber. By using the 2-chloro-1,3-butadiene-2,3-dichloro-1,3-butadiene copolymer rubber, the adhesion between the RFL adhesive composition and the core cord can be more enhanced, and excellent dynamic adhesion, excellent heat resistant adhesion, and excellent dynamic life can be attained.

Since the adhesive rubber layer is formed by crosslinking an ethylene-α-olefin elastomer compound with organic peroxide and the compressed rubber layer is formed by crosslinking an ethylene-α-olefin elastomer compound and the 2,3-dichlorobutadiene-containing polymer latex is used as a latex component, excellent dynamic adhesion, excellent heat resistant adhesion, and excellent dynamic life can be attained without using another latex component as a component of the adhesive composition.

Thus, in the present invention, by using the 2,3-dichlorobutadiene-containing polymer latex, excellent dynamic adhesion, excellent heat resistant adhesion, and excellent dynamic life can be attained, and use of another latex component is not needed, but the 2,3-dichlorobutadiene-containing polymer latex may be used in combination with another latex component within the bounds of not interfering with the effect of the present invention.

Examples of the another latex component include a natural rubber latex, a chloroprene rubber latex, a styrene-butadiene rubber latex, an acrylonitrile-butadiene rubber latex, a hydrogenated NBR latex, a carboxylated hydrogenated NBR latex, a chlorosulfonated polyethylene latex, an alkylated chlorosulfonated polyethylene latex, and a styrene-butadiene-vinylpyridine ter-polymer latex. These latexes may be used alone or in combination of two or more species.

In the latex component of the RFL adhesive composition, the content of the 2,3-dichlorobutadiene-containing polymer latex is preferably 90% by weight or more with respect to 100% by weight (solid content) of the total amounts of the latex component in the RFL adhesive composition. When this content is less than 90% by weight, adhesive properties are deteriorated, and therefore popping out of the core cord may occur.

The RFL adhesive composition used in the RFL treatment can be generally prepared by condensating resorcin with formalin in a molar ratio of resorcin to formalin of 10:1 to 1:5 (preferably 10:1 to 1:3) in the presence of a basic catalyst to prepare an 5 to 80% by weight aqueous solution of resorcin-formalin resin (initial condensate of resorcin-formalin, hereinafter, also referred to as an RF), and mixing the resulting initial condensate with a rubber latex.

In the RFL adhesive composition, the solid content of the latex is preferably 1 to 50% by weight, and more preferably 1 to 40% by weight. In addition, the solid content of the RFL adhesive composition is preferably 2 to 50% by weight, and more preferably 3 to 30% by weight. When these contents are within the above ranges, a strong adhesive force can be obtained.

In the present invention, examples of a method for applying the adhesive treatment to the core cord using the RFL adhesive composition include a method in which the core cord is immersed in the RFL adhesive composition (impregnated with the RFL adhesive composition), and then the immersed core cord is heated (baked) to be dried and thereby the RFL adhesive composition is fixed to the core cord. The heating temperature is preferably 200 to 270° C., and more preferably 210 to 250° C.

As for the adhesive treatment, first, the core cord is immersed in a first RFL adhesive composition as a first (initial) RFL treatment and then heated and dried to complete the first (initial) RFL treatment, and next, the core cord is immersed in a second RFL adhesive composition and then heated and dried to complete the second (or final) RFL treatment, that is, it is preferred that treatment by the RFL adhesive composition is performed at least twice. In such a case, the above first RFL adhesive composition may be similar to or different from the above second RFL adhesive composition. Further, treatment by the RFL adhesive composition may be performed three times or more as required.

The RFL adhesive composition preferably further contains metal oxide and a sulfur-containing vulcanization accelerator. By impregnating the core cords with the RFL adhesive composition containing the metal oxide and the sulfur-containing vulcanization accelerator in addition to the RF and the latex, and then heating the impregnated core cords to elevated temperature higher than 200° C. to be dried, dynamic adhesion between the core cords and the adhesive rubber is further enhanced, and a time for an adhesive treatment of the core cord can be significantly reduced. Accordingly, a friction transmission belt having high dynamic adhesion can be manufactured with high productivity.

As the metal oxide, for example, zinc oxide, magnesium oxide, lead oxide or a mixture of two or more species thereof are preferably used. Among others, zinc oxide is particularly preferred.

As the sulfur-containing vulcanization accelerator, thiazoles, sulfenamides, thiurams, dithiocarbamates or a mixture of two or more species thereof are preferably used. The sulfur-containing vulcanization accelerator acts more effectively for accelerating the vulcanization of ethylene-α-olefin elastomer.

Examples of the thiazoles include 2-mercaptobenzothiazole (M) and salts thereof (for example, zinc salt, sodium salt, cyclohexylamine salt, etc.), and dibenzothiazyl disulfide (DM). Among others, it is preferred to use dibenzothiazyl disulfide because excellent dynamic adhesion, excellent heat resistant adhesion, and excellent dynamic life can be attained.

Examples of the sulfenamides include N-cyclohexyl-2-benzothiazyl sulfenamide (CZ).

Examples of the thiurams include tetramethylthiuram monosulfide (TS), tetramethylthiuram disulfide (TT), and dipentamethylenethiuram tetrasulfide (TRA).

Examples of the dithiocarbamates include sodium di-n-butyldithiocarbamate (TP), zinc dimethyldithiocarbamate (PZ), and zinc diethyldithiocarbamate (EZ). In the present invention, it is particularly preferred to use zinc oxide in conjunction with dibenzothiazyl disulfide because excellent dynamic adhesion, excellent heat resistant adhesion, and excellent dynamic life can be attained.

In the RFL adhesive composition, an amount of the metal oxide to be mixed is preferably 0.1 to 10 parts by weight with respect to 100 parts by weight of solid content of the latex component in the RFL adhesive composition. In addition, an amount of the sulfur-containing vulcanization accelerator to be mixed is preferably 0.1 to 20 parts by weight with respect to 100 parts by weight of solid content of the latex component in the RFL adhesive composition. When these amounts are out of the above ranges, dynamic adhesion, heat resistant adhesion, and dynamic life may be deteriorated.

In the present invention, by impregnating the core cords with the resorcin-formalin-latex adhesive composition containing the 2,3-dichlorobutadiene-containing polymer latex (latex component), the metal oxide and the sulfur-containing vulcanization accelerator, and heating the impregnated core cords to a temperature of 200 to 270° C. to be dried, an adhesive force which is superior in dynamic adhesion can be produced between the adhesive rubber comprising ethylene-α-olefin elastomer and the core cords while securing high productivity.

In the present invention, the core cords may be treated with isocyanate or epoxy prior to being subjected to an adhesive treatment using the RFL adhesive composition. That is, the core cords may be pretreated by immersing the core cords in a solution containing an isocyanate compound or an epoxy compound, and then heating and drying it as required. This heating and drying can be performed at a temperature of 200 to 270° C.

The isocyanate compound is not particularly limited, and as the isocyanate compound, for example, polyisocyanate compounds, having two or more isocyanate groups in a molecule, such as tolylene diisocyanate, m-phenylene diisocyanate, diphenylmethane diisocyanate, hexamethylene diisocyanate and polymethylene polyphenyl isocyanate are preferably used. Also, polyhydric alcohol added-polyisocyanate obtained by reacting such a polyisocyanate compound with a compound, having two or more active hydrogen in a molecule, such as trimethylolpropane, pentaerythritol and the like; and blocked polyisocyanates formed by reacting such a polyisocyanate compound with a blocking agent such as phenols, tertiary alcohols, secondary amines or the like to block an isocyanate group of the isocyanate compound can also be suitably used as an isocyanate compound. Among others, it is particularly preferred to use polymethylene polyphenyl polyisocyanate because excellent dynamic adhesion, excellent heat resistant adhesion, and excellent dynamic life can be attained.

The epoxy compound is not particularly limited as long as it is a polyepoxy compound having two or more epoxy groups in a molecule, and as the epoxy compound, for example, reaction products of polyhydric alcohol such as ethyleneglycol, glycerin, sorbitol or pentaerithritol, or polyalkylene glycol such as polyethyleneglycol with a halogen-containing epoxy compound such as epichlorohydrin; polyhydric phenols such as resorcin, bis(4-hydroxyphenyl)dimethylethane, phenol-formaldehyde resin and resorcin-formaldehyde resin; and reaction products of a phenolic resin with a halogen-containing epoxy compound such as epichlorohydrin are preferably used. Among others, it is particularly preferred to use polyglycerol and polyglycidyl ether because excellent dynamic adhesion, excellent heat resistant adhesion, and excellent dynamic life can be attained.

A solvent for forming solutions of the isocyanate compounds and the epoxy compounds is not particularly limited and include, and water or an organic solvent can be appropriately used depending on the isocyanate compound or the epoxy compound to be used. Generally, since the isocyanate compound is chemically very active, a non-aqueous solution is employed, but for example, a compound formed by blocking an isocyanate group with phenols can be used as an aqueous solution as described above. As the organic solvent, aromatic hydrocarbons such as benzene, xylene, toluene and the like; aliphatic ketones such as methyl ethyl ketone, methyl isobutyl ketone and the like; and aliphatic alkyl carboxylate such as ethyl acetate, amyl acetate and the like can be suitably used. In the solution of the isocyanate compounds or the epoxy compounds, the concentration of the isocyanate compound or the epoxy compound is generally 5 to 50% by weight.

In the present invention, the core cords may be treated with gum after the core cords are subjected to the adhesive treatment with the RFL adhesive composition. Examples of gum used for this post-treatment include a solution formed by dissolving ethylene-α-olefin elastomer to be used for forming the compressed rubber layer and the adhesive rubber layer in an appropriate organic solvent and a solution formed by dissolving the ethylene-α-olefin elastomer compound in an appropriate organic solvent. The post-treatment can be performed by immersing the core cords in the above-mentioned solution, and then heating and drying them at 40 to 120° C.

In the present invention, high dynamic adhesion can be produced between the core cord and the adhesive rubber layer by subjecting the core cord to an adhesive treatment by use of a RFL adhesive composition containing a 2,3-dichlorobutadiene-containing polymer latex, sandwiching the treated core cords between unvulcanized rubber sheets obtained by using an ethylene-α-olefin elastomer compound and vulcanizing them to bond the core cords to the inside of the adhesive rubber layer through vulcanization, and embedding the core cords. Therefore, the friction transmission belt, in which such core cords are integrally bonded to the inside of the adhesive rubber layer comprising the ethylene-α-olefin elastomer compound through vulcanization, has a high dynamic belt life.

A force (peel adhesive force), which is exerted to peel a treated fiber code from a vulcanized rubber sheet prepared by vulcanizing (at 160° C. for 30 minutes) the core cord (treated fiber code) subjected to the adhesive treatment and the ethylene-α-olefin elastomer compound to be used for forming the adhesive rubber layer in close contact with each other, is preferably 150.0 to 300.0 (N/3 fiber codes) at room temperature. In addition, the peel adhesive force is preferably 18.0 to 30.0 (N/3 fiber codes) at 120° C. When the peel adhesive force is within the above range, the core cords are bonded to the adhesive rubber layer firmly, and more excellent dynamic adhesion, heat resistant adhesion and dynamic life can be attained.

The peel adhesive force (N/3 fiber codes) is a value obtained by a peel test shown in FIG. 4 described later. Further, a value of the peel adhesive force is an overall mean value of peak values in a specific section described later.

### [Peel Test]

In the vulcanized rubber sheet in which seven treated fiber codes are embedded, three treated fiber codes selected every other code are clamped with upper and lower chucks and simultaneously peeled off under the peeling conditions below. [Peeling conditions: distance between chucks 40 mm, peel speed 100 mm/min, an average of peak values in the section of last 60 mm (60 mm between a peeling distance of 40 mm and a peeling distance of 100 mm) of a peeling distance of 100 mm is taken as a peel force.]

Examples of the friction transmission belt of the present invention include a belt formed by integrating the adhesive rubber layer in which core cords are embedded along the longitudinal direction of the belt and the compressed rubber layer laminated onto the inside of the adhesive rubber layer by bonding, and specific examples of the friction transmission belt include a V-ribbed belt, a raw edge V-belt, and a flat belt.

Examples of the friction transmission belt of the present invention will be described by use of FIGS. 1 to 3.

FIG. 1 is a transverse sectional view (plane perpendicular to the longitudinal direction of a belt) of an example of a V-ribbed belt, and on the top face of the belt, a rubber-lined canvas layer 1 of a single layer or multilayer is formed, and the adhesive rubber layer 3 is laminated adjacent to the inside of the canvas layer. In this adhesive rubber layer, a plurality of core cords 2 of low elongation made of fiber code are embedded at some spaces along the longitudinal direction of the belt. Further, the compressed rubber layer 5 is laminated adjacent to the inside of this adhesive rubber layer. This compressed rubber layer is formed on ribs 4 spaced in rows along the longitudinal direction of the belt. In many cases, in the compressed rubber layer 5, short fibers 6 are dispersed with the fiber being oriented to the direction of width of the belt in order to enhance side pressure resistance.

FIG. 2 is a transverse sectional view of an example of a raw edge V-belt, and on the top face of the belt, a rubber-lined canvas layer 1 of a single layer or multilayer is formed as with the above case and an upper rubber layer 7 is laminated as required, and the adhesive rubber layer 3 in which the core cords 2 are embedded is laminated adjacent to the inside of this upper rubber layer as with the above case. Further, the compressed rubber layer 5 is laminated adjacent to the inside of this adhesive rubber layer. In many cases, in the compressed rubber layer 5, short fibers 6 are dispersed with the fiber being oriented to the direction of width of the belt in order to enhance side pressure resistance. A rubber-lined canvas layer 1 of a single layer or multilayer is generally laminated adjacent to the inside of the compressed rubber layer.

FIG. 3 is a transverse sectional view of an example of a flat belt, and the rubber-lined canvas layer 1, the adhesive rubber layer 3 and the compressed rubber layer 5 are laminated as with the above case.

Examples of the rubber-lined canvas layer 1 to be used may be cloths fabricated in plain weave fabrics, twill fabrics, satin fabrics using yarns of cotton, polyamide, polyethylene terephthalate, or aramide. Examples of the short fiber 6 include fibers made of nylon 6, nylon 66, polyester, cotton, vinylon, PBO, and aramide. As the upper rubber layer 7, materials conventionally known in the friction transmission belt can be used.

The friction transmission belt of the present invention can be manufactured by a heretofore known usual method, for example, the following method.

It can be manufactured by a method comprising the steps of (1) impregnating the core cords with the resorcin-formalin-latex adhesive composition containing the 2,3-dichlorobutadiene-containing polymer latex and heating and drying the core cords to be subjected to an adhesive treatment, (2) placing the core cords subjected to an adhesive treatment, obtained by the step (1), between unvulcanized ethylene-α-olefin elastomer compound sheets for forming the adhesive rubber layer to obtain a sheet, and laminating an unvulcanized ethylene-α-olefin elastomer compound sheet for forming the compressed rubber layer on the obtained sheet to obtain a laminate, and (3) pressurizing and heating the laminate obtained in the step (2) to vulcanize it. In the step (2) of this production method, the unvulcanized ethylene-α-olefin elastomer compound sheet for forming the adhesive rubber layer can be prepared by using an ethylene-α-olefin elastomer compound containing ethylene-α-olefin elastomer and organic peroxide (ethylene-α-olefin elastomer compound for forming the adhesive rubber layer). Thereby, the friction transmission belt described above can be produced well. Such a method of producing a friction transmission belt also constitutes the present invention.

The adhesive treatment in the step (1) can be performed by subjecting the core cords to an adhesive treatment similarly using the resorcin-formalin-latex adhesive composition described. The step (2) can be performed by following the same procedure as in a conventionally known method of producing a belt using the core cords subjected to an adhesive treatment, obtained by the step (1), and the ethylene-α-olefin elastomer compound for forming the adhesive rubber layer and the compressed rubber layer described above. The step (3) can also be performed by following the same procedure as in a conventionally known method of producing a belt. By the way, the above-mentioned pretreatment may be carried out before the adhesive treatment. Also, the above-mentioned post-treatment may be carried out after the adhesive treatment.

Hereinafter, the example of a method of producing a V-ribbed belt of friction transmission belts will be described.

After one or a plurality of rubber-coated canvases and unvulcanized sheets for an adhesive rubber layer are wound around the peripheral side of a cylindrical forming drum with a smooth surface, core cords are spun in a spiral manner thereon. Further, the unvulcanized sheet for an adhesive rubber layer is wound thereon, and then an unvulcanized sheet for a compressed rubber layer is wound around this to obtain a laminate. This laminate is heated and pressurized in a vulcanizer to be vulcanized to obtain an annular substance. Next, this annular substance is looped over a drive roller and a driven roller, and a plurality of ribs are formed on the surface with a grinding wheel while running the belt under a prescribed tension. Thereafter, this annular substance is further looped over another drive roller and another driven roller and cut to the prescribed width while running the belt to obtain a V-ribbed belt as a product.

In the friction transmission belt of the present invention, the adhesive rubber layer is formed by crosslinking an ethylene-α-olefin elastomer compound with organic peroxide, the compressed rubber layer is formed by crosslinking an ethylene-α-olefin elastomer compound, and the core cord embedded in the adhesive rubber layer is subjected to an adhesive treatment by a resorcin-formalin-latex adhesive composition containing a 2,3-dichlorobutadiene-containing polymer latex. Therefore, the friction transmission belt has excellent adhesive properties (adhesion between the adhesive rubber layer and the core cords, adhesion between the adhesive rubber layer and the compressed rubber layer, etc.) such as dynamic adhesion and heat resistant adhesion in running the belt. In addition to this, the friction transmission belt is also superior in desired performance such as heat resistance, abrasion resistance and an abnormal noise-preventing property.

### BRIEF DESCRIPTION OF THE DRAWINGS

FIG. 1 is an example of a transverse sectional view (plane perpendicular to the longitudinal direction of a belt) of a V-ribbed belt,

FIG. 2 is an example of a transverse sectional view of a raw edge V-belt,

FIG. 3 is an example of a transverse sectional view of a flat belt,

FIG. 4 is a schematic view illustrating code peel test, and

FIG. 5 is a schematic view showing the situation of a running test of a friction transmission belt.

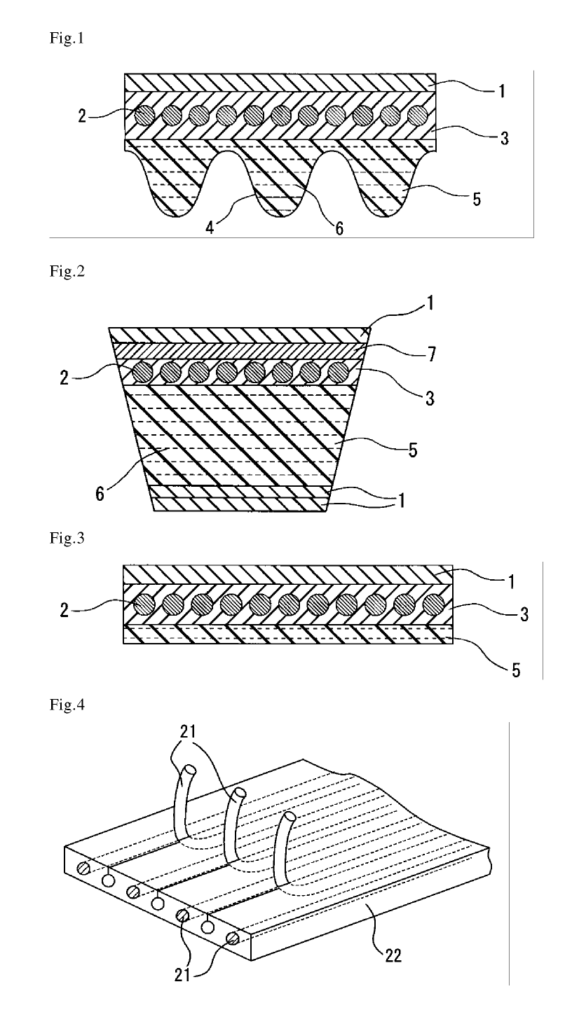

### DESCRIPTION OF SYMBOLS

1 rubber-lined canvas layer
2, 21 core cords (treated fiber code)
3 adhesive rubber layer
4 rib
5 compressed rubber layer
6 short fiber
7 top rubber layer
11 drive pulley
12 driven pulley
13 idler pulley
14 tension pulley
22 vulcanized rubber sheet

### BEST MODE FOR CARRYING OUT THE INVENTION

Hereinafter, the present invention will be described in more detail by way of examples, but the present invention is not limited to these examples. In addition, “part(s)” and “%” refer to “part(s) by weight” and “% by weight” in Examples, unless otherwise specified.

### Production of Adhesive Rubber Layer and Compressed Rubber Layer

Each composition for an adhesive rubber layer was prepared from the rubber formulation shown in Tables 1 and 2, and this composition was kneaded with a Banbury mixer and then rolled with a calendaring roll to prepare an unvulcanized sheet of a rubber compound for an adhesive rubber layer (Formulations 1 to 3). Each composition for a compressed rubber layer was prepared from the rubber formulation shown in Table 3 to prepare an unvulcanized sheet of a rubber compound for a compressed rubber layer similarly (Formulations 4 to 5).

Further, commercialized products used are as follows.

1) EPDM polymer 1 (ethylene-propylene-diene rubber): “EP24” (ethylene content 54% by weight, ethylidene norbornane (ENB) 4.5% by weight, Mooney viscosity ML₁₊₄ (100° C.) 65, produced by JSR Corporation)
2) EPDM polymer 2 (ethylene-propylene-diene rubber): “Mitsui 4045” (ethylene content 54% by weight, ethylidene norbornane (ENB) 8.1% by weight, Mooney viscosity ML₁₊₄ (100° C.) 45)
3) Antioxidant: “Nocrac 224” (produced by OUCHI SHINKO CHEMICAL INDUSTRIAL Co., Ltd.)
4) Peroxide: dicumyl peroxide

### 5) Oil: “Sunpar 2280” (Japan Sun Oil Co., Ltd.)

6) Nylon short fiber (nylon-6,6, type T5 length 1 mm, produced by Asahi Kasei Corp.)
7) FEF carbon (TOKAI CARBON Co., Ltd.)
8) Sulfur “Oil-treated sulfur” (produced by Karuizawa Smelter)
9) Vulcanization accelerator 1: “NOCCELER TT” (produced by OUCHI SHINKO CHEMICAL INDUSTRIAL Co., Ltd.)
10) Vulcanization accelerator 2: “NOCCELER TRA” (produced by OUCHI SHINKO CHEMICAL INDUSTRIAL Co., Ltd.)
11) Vulcanization accelerator 3: “NOCCELER CZ” (produced by OUCHI SHINKO CHEMICAL INDUSTRIAL Co., Ltd.)
12) Vulcanization accelerator 4: Tetramethylthiuram monosulfide
13) Vulcanization accelerator 5: Tellurium diethyldithiocarbamate

TABLE 1
Adhesive rubber

| | Formulation 1 |
|---|---|
| EPDM polymer 1 | 100 |
| Zinc oxide | 5 |
| Antioxidant | 1 |
| Peroxide | 5 |
| Oil | 10 |
| Nylon short fiber | — |
| FEF carbon | 60 |

TABLE 2
Adhesive rubber

| | Formu- | Formu- | Formu- |
|---|---|---|---|
| | lation 2 | lation 3 | lation 2′ |
| EPDM polymer 1 | — | — | 100 |
| EPDM polymer 2 | 100 | 100 | — |
| Stearic acid | 0.5 | 0.5 | — |
| Zinc oxide | 5 | 5 | 5 |
| FEF carbon | — | — | 60 |
| HAF carbon black | 40 | 40 | — |
| Paraffin oil | 15 | 15 | 10 |
| Hydrous silica | 15 | 15 | — |
| Vulcanization accelerator 1 | 1 | — | 1 |
| Vulcanization accelerator 2 | 0.5 | 0.6 | 0.5 |
| Vulcanization accelerator 3 | 1 | — | 1 |
| Vulcanization accelerator 4 | — | 0.5 | — |
| Vulcanization accelerator 5 | — | 2 | — |
| Sulfur | 1 | 0.8 | 1 |

TABLE 3
Compressed rubber

| | Formulation 4 | Formulation 5 |
|---|---|---|
| EPDM polymer 1 | 100 | 100 |
| Zinc oxide | 5 | 5 |
| Antioxidant | 1 | 1 |
| Peroxide | 2.7 | — |
| Oil | 10 | 10 |
| Nylon short fiber | 15 | 15 |
| FEF carbon | 60 | 60 |
| Sulfur | — | 1.5 |
| Vulcanization accelerator 1 | — | 1 |
| Vulcanization accelerator 2 | — | 0.5 |
| Vulcanization accelerator 3 | — | 1 |

### Production of RFL Adhesive Composition

0.5 parts by weight of sodium hydroxide was dissolved in 97.4 parts by weight of water, and 6.7 parts by weight of resorcin and 6.3 parts by weight of formalin (concentration 37% by weight) were dissolved in turn, and the resulting mixture was aged for 2 hours to prepare an aqueous solution of resorcin-formalin resin (initial resorcin-formalin condensate) (referred to as an RF) of R/F ratio (a molar ratio of resorcin to formalin)=1/1.2. To this RF aqueous solution, 2-chloro-1,3-butadiene-2,3-dichloro-1,3-butadiene copolymer rubber latex (produced by Tosoh Corp., “SKYPRENE LH430”, solid content 32%”) was added (solid content of latex is 307.1 parts by weight), and 582 parts by weight of water was further added to adjust the solid content to 10.8%. Thereafter, the mixture was stirred and aged for 12 hours to prepare an RFL adhesive composition (formulation A).

Further, RFL adhesive compositions (formulations B to F) were prepared by following the same procedure as in the above description except for changing the composition to the formulation shown in Table 4.

The contents shown in Table 4 are as follows.

DM: Dibenzothiazyl disulfide

Chlorosulfonated polyethylene latex: trade name “CMS Latex 450”, produced by SUMITOMO SEIKA CHEMICALS Co., Ltd., solid content 32%

Vinylpyridine-SBR latex: trade name “JSR 0650”, produced by JSR Corp., solid content 40%

Chloroprene latex: trade name “water base Shoprene 842A”, produced by Showa Denko Elastomers K.K., solid content 50%

TABLE 4
RFL

| | A | B | C | D | E | F |
|---|---|---|---|---|---|---|
| 2,3-dichlorobutadiene latex (32%) | 307.1 | 280.0 | — | — | — | 250.3 |
| Chlorosulfonated polyethylene latex (40%) | — | — | 222.0 | — | — | 22.3 |
| Vinylpyridine-SBR latex (40%) | | — | — | 245.0 | — | — |
| Chloroprene latex (50%) | — | — | — | — | 196.0 | — |
| DM/ZnO (43%) | — | 20.3 | 20.0 | — | — | 20.0 |
| Resorcin | 6.7 | 6.3 | 6.3 | 6.7 | 6.7 | 6.3 |
| 37% formalin | 6.3 | 5.7 | 5.7 | 6.3 | 6.3 | 5.7 |
| Sodium hydroxide | 0.5 | 0.5 | 0.5 | 0.5 | 0.5 | 0.5 |
| Water | 679.4 | 687.2 | 745.5 | 741.5 | 790.5 | 694.9 |
| Total | 1000.0 | 1000.0 | 1000.0 | 1000.0 | 1000.0 | 1000.0 |

### Production of Gum

Gum was prepared by mixing 10 parts by weight (solid matter) of a rubber compound (formulation 1) using the adhesive rubber layer shown in Table 1 in 90 parts by weight of toluene.

### EXAMPLES 1 TO 4 AND COMPARATIVE EXAMPLES 1 TO 7

### Treatment of Core Cord

A pretreatment was applied to polyethylene terephthalate core cords (PET code, 1000 denier, /2×3, doubling twist 9.5 T/10 cm (Z), primary twist 21.9 T/10 cm, produced by Teijin Ltd.) by immersing the core cords in a toluene solution of isocyanate (isocyanate solid content 20% by weight), and then heating them at a temperature of 240° C. for 40 seconds to be dried.

Next, an adhesive treatment was applied to the polyethylene terephthalate core cords thus subjected to the pretreatment by immersing the core cords in the obtained RFL adhesive composition, heating them at a temperature of 230° C. for 80 seconds to be dried.

Subsequently, by immersing the polyethylene terephthalate core cords thus treated in gum, and then heating them at a temperature of 60° C. for 40 seconds to be dried, an adhesive treatment (post-treatment) was applied to the polyethylene terephthalate core cords.

### (Preparation of Friction Transmission Belt)

After a canvas and the above-mentioned unvulcanized sheet of a rubber compound for an adhesive rubber layer were wound around the side of a cylindrical forming drum with a smooth surface, the above-mentioned polyethylene terephthalate core cords subjected to an adhesive treatment were spun in a spiral manner around these sheets. Further, the unvulcanized sheet of a rubber compound for an adhesive rubber layer was wound thereon, and then the unvulcanized sheet of a rubber compound for a compressed rubber layer was wound around this to obtain a laminate. This laminate was heated and pressurized at an internal pressure of 6 kgf/cm² and an external pressure of 9 kgf/cm² at a temperature of 165° C. for 35 minute in a vulcanizer to be vulcanized by steam to obtain an annular substance. Next, this annular substance was looped over a first drive system consisting of a drive roller and a driven roller, and a plurality of ribs are formed on the surface with a grinding wheel while running the belt under a prescribed tension. Thereafter, this annular substance was further looped over a second drive system consisting of other drive roller and driven roller and cut to the prescribed width while running the belt to obtain a V-ribbed belt having three ribs and a peripheral length of 1000 mm as a product. Incidentally, Formulations of the unvulcanized sheet of a rubber compound for an adhesive rubber layer and the unvulcanized sheet of a rubber compound for a compressed rubber layer, the treating agent for an RFL adhesion, and the gum used for the production of the respective V-ribbed belt are as shown in Table 5.

### EXAMPLES 5 AND 6

Treatment of core cord and preparation of friction transmission belt were performed by following the same procedure as in Example 1 except for using polyethylene naphthalate core cords (PEN code, 1000 denier, /2×3, doubling twist 9.5 T/10 cm (Z), primary twist 21.9 T/10 cm, produced by Teijin Ltd., Example 5) and aramide core cords (Aramide code, 1000 denier, /2×3, doubling twist 9.5 T/10 cm (Z), primary twist 21.9 T/10 cm, produced by Teijin Ltd., Example 6) in place of polyethylene terephthalate core cords.

### [Evaluation]

According to the following methods and conditions, an adhesion test (peel adhesive force, situation of break) and a belt running test (peeled length after running) were performed and evaluated. The results are shown in Table 5.

### (Adhesion Test)

### (1) Measurement of Peel Adhesive Force

As a peel test, a force (peel adhesive force), which is exerted to peel a treated fiber code from a vulcanized rubber sheet prepared by vulcanizing (at 160° C. for 30 minutes) the core cord (treated fiber code) subjected to the adhesive treatment and the ethylene-α-olefin elastomer compound (formulations 1 to 3) to be used for forming the adhesive rubber layer in close contact with each other, was measured. The used core cords and compounds (formulations 1 to 3) are as shown in Table 5.

The peel tests were carried out under conditions of room temperature (RT) and 120° C. by the following method.

As shown in FIG. 4, samples of the vulcanized rubber sheet 22, in which seven treated fiber codes 21, 21, . . . are embedded, are prepared. Three treated fiber codes 21, 21, 21 selected every other code from the seven treated fiber codes are clamped with upper and lower chucks and simultaneously peeled off under the peeling conditions below.

By the way, values of the peel adhesive force in Table 4 are an overall mean value of peak values in a specific section described below.

### [Peeling Conditions]

Distance between chucks: 40 mm
Peel speed: 100 mm/min
Peeling distance: 100 mm [an average of peak values in the section of last 60 mm (60 mm between a peeling distance of 40 mm and a peeling distance of 100 mm) of this 100 mm is taken as a peel adhesive force]

### (2) Situation of Break

The situations of break in bonded articles in measuring the peel adhesive force described above were observed. The observations were visually performed according to the following criteria.

R: Cohesion break of rubber
R-C: Peel at the interface between the rubber and the code

### (Running Test of Friction Transmission Belt)

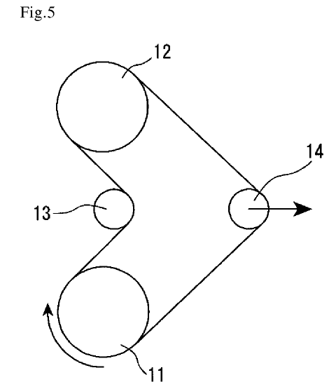

As shown in FIG. 5, a V-ribbed belt thus obtained was looped over a belt drive system consisting of a drive pulley 11 (diameter 120 mm), a driven pulley 12 (diameter 120 mm), and an idler pulley 13 (diameter 70 mm) and a tension pulley 14 (diameter 55 mm), which are placed between the pulleys 11 and 12. In addition, the idler pulley was engaged with the backside of the belt.

In an atmosphere of a temperature of 130° C., the load of the driven pulley was set at 16 horsepower, the initial tension of the tension pulley was set at 85 kgf, and the drive pulley is driven at a rotational speed of 4900 rpm to run the belt for 24 hours, and the peeled length (mm) at the interface between the core cords and the adhesive rubber of the belt was measured after running.

TABLE 5

| | | | Example | Example | Example | Example | Example | Example | Compar. |
|---|---|---|---|---|---|---|---|---|---|
| | | | 1 | 2 | 3 | 4 | 5 | 6 | Ex. 1 |
| Adhesive rubber layer | | | Formu- | Formu- | Formu- | Formu- | Formu- | Formu- | Formu- |
| | | | lation 1 | lation 1 | lation 1 | lation 1 | lation 1 | lation 1 | lation 1 |
| Compressed rubber | | | Formu- | Formu- | Formu- | Formu- | Formu- | Formu- | Formu- |
| layer | | | lation 4 | lation 4 | lation 5 | lation 4 | lation 4 | lation 4 | lation 4 |
| Core wire | | | PET | PET | PET | PET | PEN | aramide | PET |
| 1st bath (pretreatment) | | | isocyanate | isocyanate | isocyanate | isocyanate | isocyanate | isocyarate | isocyanate |
| 2nd bath (RFL) | | | A | B | A | F | A | A | C |
| 3rd bath (gum) | | | gum | gum | gum | gum | gum | gum | gum |
| Adhesion | Adhesion | RT | 156.4 | 172.2 | 162.8 | 158.0 | 152.0 | 108.2 | 143.7 |
| test | force | 120° C. | 18.6 | 20.3 | 19.1 | 19.1 | 18.3 | 17.5 | 17.7 |
| | (N/3 | | | | | | | | |
| | fiber | | | | | | | | |
| | codes) | | | | | | | | |
| | Break | RT | R | R | R | R | R | R | R |
| | mode | 120° C. | R | R | R | R | R | R | R, R-C |

| | | | | | | | | |
|---|---|---|---|---|---|---|---|---|
| Belt | Peeled length | no | no | no | no | no | no | 135 |
| running | after running | defect | defect | defect | defect | defect | defect | |
| | for 24 hrs (mm) | | | | | | | |

| | | | Compar. | Compar. | Compar. | Compar. | Compar. | Compar. |
|---|---|---|---|---|---|---|---|---|
| | | | Ex. 2 | Ex. 3 | Ex. 4 | Ex. 5 | Ex. 6 | Ex. 7 |
| Adhesive rubber layer | | | Formu- | Formu- | Formu- | Formu- | Formu- | Formu- |
| | | | lation 1 | lation 1 | lation 2 | lation 3 | lation 2 | lation 2′ |
| Compressed rubber | | | Formu- | Formu- | Formu- | Formu- | Formu- | Formu- |
| layer | | | lation 4 | lation 4 | lation 4 | lation 4 | lation 5 | lation 4 |
| Core wire | | | PET | PET | PET | PET | PET | PET |
| 1st bath (pretreatment) | | | isocyanate | isocyanate | isocyanate | isocyanate | isocyanate | isocyanate |
| 2nd bath (RFL) | | | D | E | A | A | A | A |
| 3rd bath (gum) | | | gum | gum | gum | gum | gum | gum |
| Adhesion | Adhesion | RT | 45.6 | 112.6 | 142.5 | 136.6 | 145.6 | 148.1 |
| test | force | 120° C. | 14.0 | 18.0 | 17.2 | 16.5 | 17.9 | 18.2 |
| | (N/3 | | | | | | | |
| | fiber | | | | | | | |
| | codes) | | | | | | | |
| | Break | RT | R-C | R, R-C | R | R | R | R |
| | mode | 120° C. | R-C | R, R-C | R | R | R | R |

| | | | | | | | |
|---|---|---|---|---|---|---|---|
| Belt | Peeled length | popping | 468 | popping | 550 | 221 | popping |
| running | after running | out after | | out after | | | out after |
| | for 24 hrs (mm) | 15 hours | | 18 hours | | | 21 hours |

It becomes evident from the results of Examples 1 to 4 in Table 5 that when the following conditions (i) and (ii) are satisfied in using EPDM in the adhesive rubber layer and the compressed rubber layer, under both temperature conditions of room temperature and 120° C., a peel adhesive force is good, and peeling does not occur and dynamic life is excellent even in a long-duration running.

(i) Both the adhesive rubber layer and the compressed rubber layer are a layer provided through crosslinking by organic peroxide, or the adhesive rubber layer is a layer provided through crosslinking by organic peroxide and the compressed rubber layer is a layer provided through vulcanization by sulfur.
(ii) 2-chloro-1,3-butadiene-2,3-dichloro-1,3-butadiene copolymer is used as a latex component of the adhesive composition (90% by weight or more in latex solid matter).

It becomes evident from the results of Examples 5 and 6 that excellent properties are attained similarly even though the core cord is PEN or aramide. Therefore, in Examples, excellent adhesive properties (dynamic adhesion and heat resistant adhesion) and dynamic life can be attained.

On the other hand, it becomes evident from the results of Comparative Examples 1 to 3 that when only components other than 2-chloro-1,3-butadiene-2,3-dichloro-1,3-butadiene copolymer are used as a latex component of the adhesive composition, the adhesive force of the core cord is not good and peeling occurs even though the adhesive rubber layer is a layer provided through crosslinking by organic peroxide. In addition, it becomes evident from the results of Comparative Examples 4 to 7 that when the adhesive rubber layer is a layer provided through vulcanization by sulfur, peeling occurs even though 2-chloro-1,3-butadiene-2,3-dichloro-1,3-butadiene copolymer is used as a latex component of the adhesive composition.

### INDUSTRIAL APPLICABILITY

The friction transmission belt of the present invention can be suitably applied to belts for transmission such as belts for driving of automobile's auxiliaries (dynamo, air conditioner, power steering and the like).

1. A friction transmission belt formed by laminating an adhesive rubber layer in which core cords are embedded along the longitudinal direction of the belt and a compressed rubber layer,
wherein said adhesive rubber layer is formed by crosslinking an ethylene-α-olefin elastomer compound with organic peroxide,
said the compressed rubber layer is formed by crosslinking an ethylene-α-olefin elastomer compound, and
said core cord is subjected to an adhesive treatment by a resorcin-formalin-latex adhesive composition containing a 2,3-dichlorobutadiene-containing polymer latex.

2. The friction transmission belt according to claim 1,
wherein the 2,3-dichlorobutadiene-containing polymer latex contains 2-chloro-1,3-butadiene-2,3-dichloro-1,3-butadiene copolymer rubber.

3. The friction transmission belt according to claim 1 or 2,
wherein both an ethylene-α-olefin elastomer compound for forming the adhesive rubber layer and an ethylene-α-olefin elastomer compound for forming the compressed rubber layer contain ethylene-propylene-diene rubber.

4. A method of producing a friction transmission belt formed by laminating an adhesive rubber layer in which core cords are embedded along the longitudinal direction of the belt and a compressed rubber layer, comprising the steps of
(1) impregnating the core cords with the resorcin-formalin-latex adhesive composition containing the 2,3-dichlorobutadiene-containing polymer latex and heating and drying the core cords to be subjected to an adhesive treatment,
(2) placing the core cords subjected to an adhesive treatment, obtained by said step (1), between unvulcanized ethylene-α-olefin elastomer compound sheets for forming the adhesive rubber layer to obtain a sheet, and laminating an unvulcanized ethylene-α-olefin elastomer compound sheet for forming the compressed rubber layer on the obtained sheet to obtain a laminate, and
(3) pressurizing and heating the laminate obtained in said step (2) to vulcanize it,
wherein said unvulcanized ethylene-α-olefin elastomer compound sheet for forming the adhesive rubber layer is prepared by using an ethylene-α-olefin elastomer compound containing ethylene-α-olefin elastomer and organic peroxide.
